(19) United States
(12) Patent Application Publication
(10) Pub. No.: US 2005/0027885 A1
(43) Pub. Date: Feb. 3, 2005

(54) Communication method and an interface device

(76) Inventors: Ronald Joseph Dedera, Wellington (NZ); Andrew Noel Dowden, Wellington (NL)

Correspondence Address: SNELL & WILMER;ONE ARIZONA CENTER, 400 EAST VAN BUREN, PHOENIX, AZ, 850040001, US

(21) Appl. No.: 10/495,524

(22) PCT Filed: Nov. 15, 2002
(86) PCT No.: PCT/NZ02/00252

(30) Foreign Application Priority Data
Nov. 15, 2001 (NZ) 515524

(51) Int. Cl. G06F 15/16

(52) U.S. Cl. 709/246

(57) ABSTRACT

An interface device enabling communication between devices irrespective of the communication protocol of each device. The interface device consists of a plurality of software engines (L1-L3) operating at successive levels of abstraction. The lowest level (L1) deals with device and interfacing whilst the highest level (L3) deals with the business application layer. The interface to each device thus requires only data regarding the interface to a single device rather than specific interface information for any two given devices.

### FIELD OF THE INVENTION

The present invention relates to a method of communicating between devices and an interface device. More particularly, the present invention relates to a method and device that facilitates communication between a plurality of devices operating under different protocols and/or on different platforms.

### BACKGROUND OF THE INVENTION

A number of problems exist when attempting to interface to different devices, or to communicate between one or more different platforms. A large number of different protocols, syntax and interface technologies are used. Each industry and category of device has developed over time to use a distinct style and type of protocol, with different expectations. Computer equipment and peripherals, industrial equipment, wireless communication devices, household appliances etc. may all utilise different communication protocols.

The system integrator is faced with the problem of learning the required protocol (hand shaking), syntax, and protocol timing, before they can provide a “solution” for any given application. This leads to a tendency to use the same brand of product to achieve compatibility or to replace a number of devices during an integration project. This is expensive and can limit the selection of devices and prevent the best device for a task being selected.

Such interfacing is typically performed on a device by device basis. To enable an interface device to operate with a large number of devices requires a large number of interfaces to be designed for each pair of devices which are to intercommunicate. This is a complex and time consuming process.

This approach requires complex drivers to be written for specific interface applications. The cost of producing such drivers limits compatibility of devices so that many legacy devices may not be supported.

It would be desirable to depart from the current methods of integration which generally rely on predefined standards as to feature set (often the lowest common denominator), strict adherence to an industry “device model” (sometimes an existing device), or updating the onboard software (firmware) of all devices to a new standard. None of these methods easily support existing legacy devices and are unlikely to be able to include new features or functions as competitive improvements. There is no apparent path for migration to a universal device interface whilst maintaining compatibility with existing devices.

### STATEMENT OF THE INVENTION

It is an object of the present invention to provide a communication method and an interface device that facilitates communication with any type of device whilst reducing the time required to develop interfaces, or to at least provide the public with a useful choice.

According to a first aspect of the invention there is provided a method of communicating between a first device operating under a first protocol and a second device operating under a second protocol, the method comprising the steps of:
i. receiving data from the first device according to the first protocol;
ii. extracting the data according to an intermediate data format;
iii. reformatting the data according to the second protocol; and
iv. transmitting the data to the second device according to the second protocol.

There is further provided an interface device including:

a data port;

a first interface layer for handling device interface with the data port;

a second layer for handling device specific resources; and

a third layer for handling session functionality.

Each layer is preferably a software engine of common design.

There is also provided a method of transforming data from a first protocol to a second protocol by sequentially processing data by a plurality of software engines which process data at different levels of abstraction.

There is further provided an interface device including a plurality of software engines each including a workspace and a command set wherein the software engines intercommunicate and process information at different levels of abstraction.

There is also provided a system for providing an abstract interface to communicate with a standard device including:
i. a chain of two or more software engines wherein each software engine is upper interfaced to the software engines preceding it and lower interfaced to the software engine following it;
ii. a first software engine in the chain providing an upper interface; and
iii. a last software engine in the chain adapted to manage and execute a lower interface with a standard device;
   wherein the upper interface of the first software engine provides an interface of the highest level of abstraction and each successive member of the chain provides a decreasing level of abstraction, wherein each member transforms data received through its upper and lower interfaces according to that member's level of abstraction

### BRIEF DESCRIPTION OF THE DRAWINGS

The invention will now be described by way of example with reference to the accompanying drawings in which:

FIG. 1: shows a schematic layout of an interface device;

FIG. 2: shows a layer 1 software engine of the device of FIG. 1;

FIG. 3a: shows a layer 2 software engine (of type L2(a)) of the device of FIG. 1;

FIG. 3b: shows a layer 2 software engine (of type L2(b)) of the device of FIG. 1;

FIG. 4: shows a layer 3 software engine of the device of FIG. 1;

FIG. 5: illustrates data flows for communication of data between two ports;

FIG. 6: shows a configuration in which the interface device is incorporated within a PC connected to a number of peripherals; and

FIG. 7: shows an implementation in which an interface device bridges communications between a PC and other devices.

FIG. 8: shows an implementation in which a layer 1 software engine drives multiple devices

FIG. 9: shows a system in which multiple interface devices are interconnected in “session”

### DETAILED DESCRIPTION OF EMBODIMENTS OF THE INVENTION

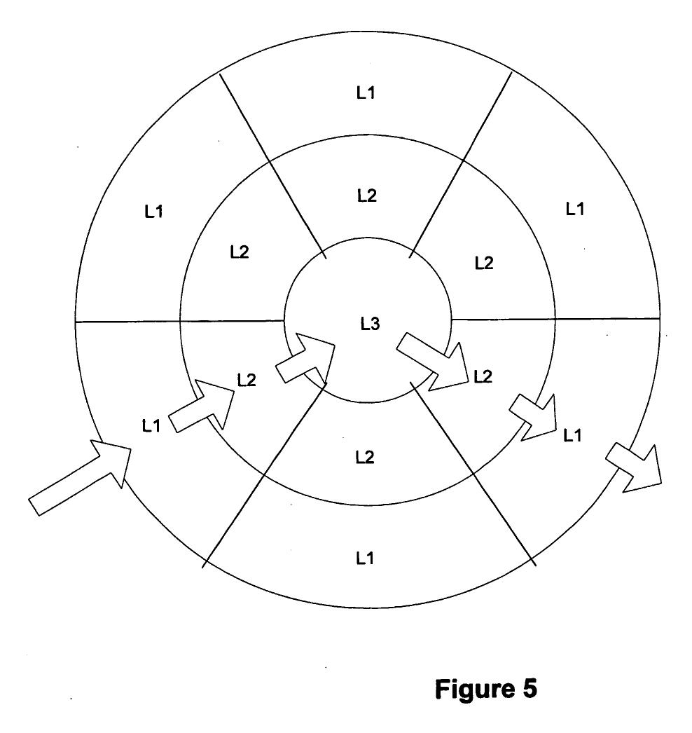

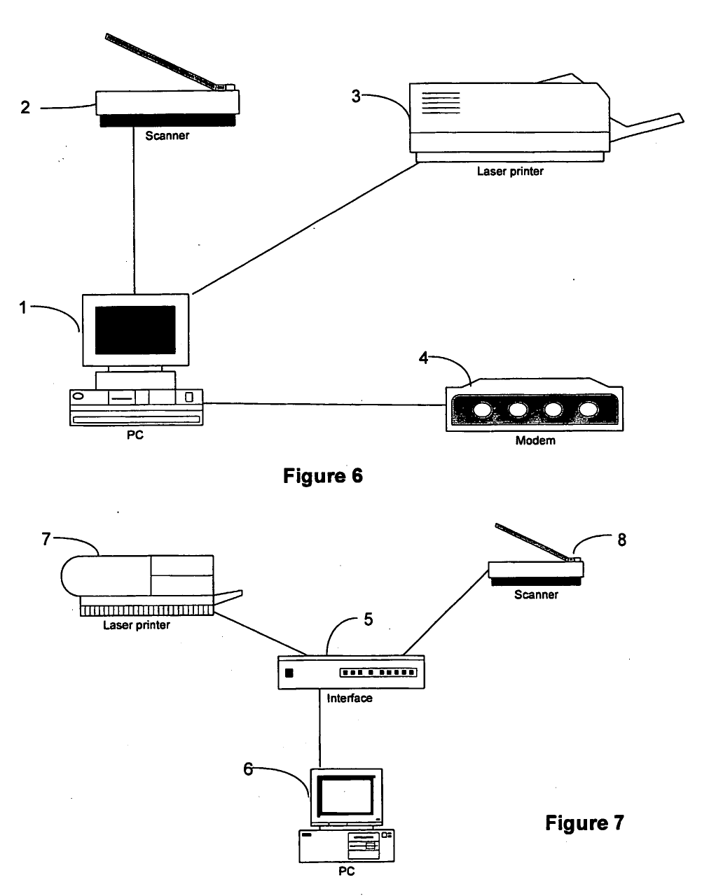

Referring firstly to FIGS. 6 and 7 two possible hardware configurations are shown. In FIG. 6 a PC 1 is connected directly via its ports to scanner 2, laser printer 3 and modem 4. Typically, serial and parallel ports of PC 1 is employed for communication between devices (such as RS232, RS485, RS488, RS530, RS449, RS422, TTY, IEEE-1394/FireWire, USB Type 1 or 2, or any other Bit Stream communication transport layer). It will be appreciated that any type of device could be substituted for devices 2 to 4 and that other types of computer or microprocessor could be substituted for PC 1.

FIG. 7 shows an alternative configuration in which interface device 5 acts as a bridge between PC 6, laser printer 7 and scanner 8. In this case interface device 5 configures and controls the ports to enable intercommunication between the devices. Interface device 5 may include a microprocessor such as an Intel StrongARM processor (e.g. SA1100, SA1110); a Motorola Coldfire Series processor (e.g. MCF5307, MCF5272, MCF5407 etc); an Intel(R) Architecture processor (e.g. 80386EX, 80486DX4, Pentium(R) class); a Motorola PowerPC processor (e.g. MPC603E, MPC740 (generically MPC7xxx, MPC7xx,MPC6xx, PowerQUICC/II e.g. MPC8255 (generically MPC85xx, MPC82xx, MPC8xx))etc.

Rather than developing a specific driver for communication between two specific devices the present invention provides an interface device that can communicate with each device and translate communications according to a first protocol into communications according to a second protocol. This means that the interface device requires only information as to the interface requirements of each connected device and not a separate driver or configuration for communication between every combination of devices.

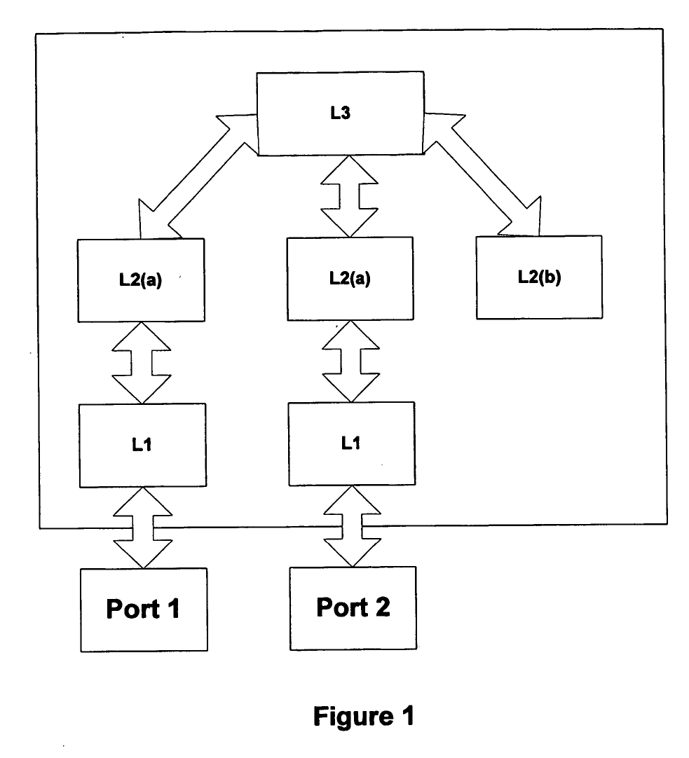

Referring now to FIG. 1 a block diagram of the software engines of an interface device is shown. The software engine consists of three layers of objects L1, L2 and L3. Each object L1, L2 and L3 is based upon a common software engine. Each layer operates at an increased level of abstraction from layer L1 to layer L3. In this way the interface with layer L3 is via a high-level data format whereas layer L1 deals with interfacing at the device specific level.

The first layer, L1, is concerned with issues of protocol and port settings. Layer 1 deals with syntax, protocol and device-interface timing as a data-driven software engine. It deals with issues of protocol such as error checking etc.

Layer 2, L2, deals with device specific resources and low level business logic. It handles device settings, device data queues, defaults, limits (including combinations allowed and disallowed), mapping (restrictive device-proprietary settings to and from generic settings), time out controls, failure over behaviour, device status, audit, customisation, help, control, logging, configuration, device identification and interrogation of configuration etc.

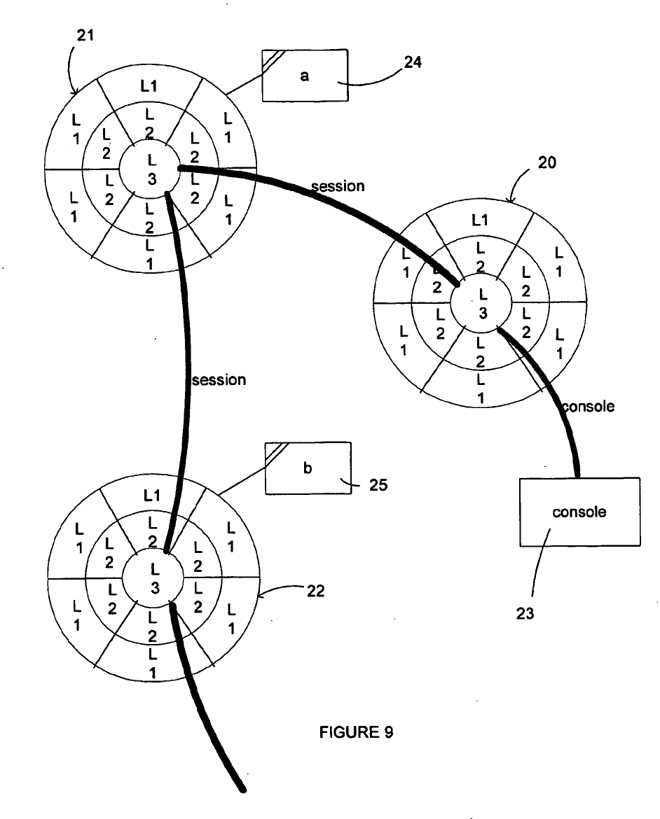

The third layer, L3, handles the business application layer. Layer L3 is at the highest level of abstraction and allows communication with other L3 layers using a high-level data format. This includes session functionality (user interface to available resources and high level business logic—see FIG. 9). Session functionality includes a user interface controlling the available functions seen by a requesting party. This layer typically includes a transaction table with properties to identify which functions are available, what settings may be changed and provides context sensitive help. The session functionality may include error handling, transaction counters, audit trail, status information, audit information, security etc. This layer controls the operation of lower layers to ensure that desired operations are performed.

Layer 3 is responsible for cross communication and mapping (inter-device and multi-user connections). Layer 3 also supports the holding of residual data (FIFO transaction and audit data records).

Alternatively, the high-level business logic could be devolved down to Layer 2 (for a device), where it is handled in a device-centric manner, with other devices slaved to this master device. This would leave Layer L3 only handling cross communication.

Alternatively, the high-level business logic could be a dedicated Layer 2 (for a user), where it is handled in a business-logic centric manner, with other devices allocated (as required) to this business application. This would typically be controlling a Layer 1, communicating to a user or third-party application. This would also leave Layer L3 only handling cross communication.

Each software engine L1 to L3 is a common software engine: each software engine includes a Toolbox containing a command set and a Workspace for command data and non command data. The command set may be a common command set for all layers or specific command sets for each layer. The operation of each software engine is defined by data relating to that layer. The data defining the operation of each layer may be stored in memory at start up or be dynamically generated.

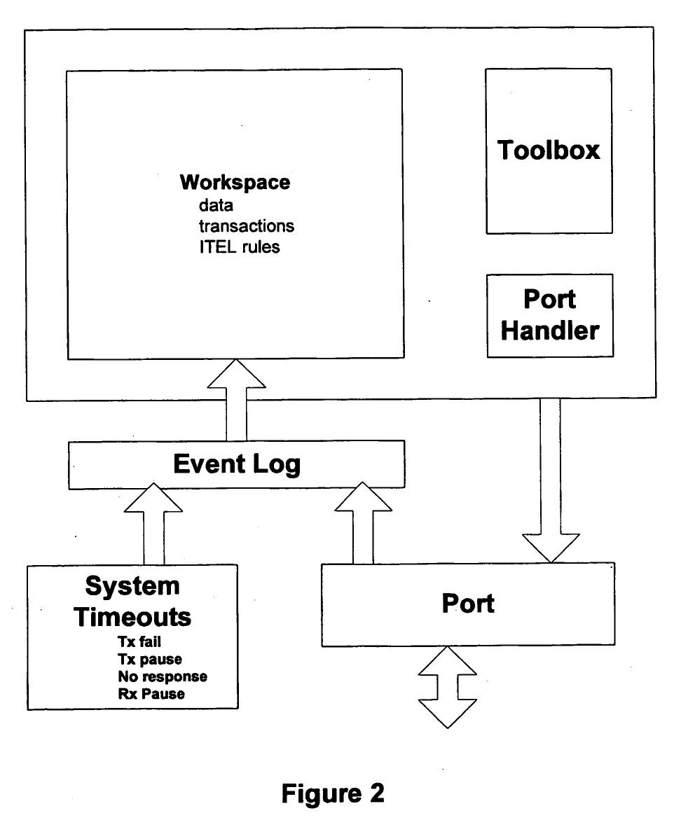

Referring now to FIG. 2, a layer 1 data engine is shown. It includes a memory Workspace that handles data, transactions and an idle-state manager. The idle-state manager uses an “Idle Task Event List” (ITEL), with Rules (parsing structure, transaction call), each with an Active/Inactive state. The Toolbox may include commands for string manipulation, checksum operations, arithmetic operations, conditional branching, event management, inter-task messaging, ITEL management, data conversion, time/date manipulation, debug tools and Port Handler calls. The ITEL Rules are triggered when events such as the Event Log buffer is full, a timeout occurs, or a data packet is received. A common Toolbox of available commands is provided for each software engine. The transactions utilise commands from the Toolbox to process data in the Workspace. The Toolbox also includes commands to control the Port Handler (which controls the Port).

Data from the Port is supplied to the Event Log and data from the Event Log can be accessed by the Workspace if required. System Timeouts (relating to port traffic) are also reported to the Event Log.

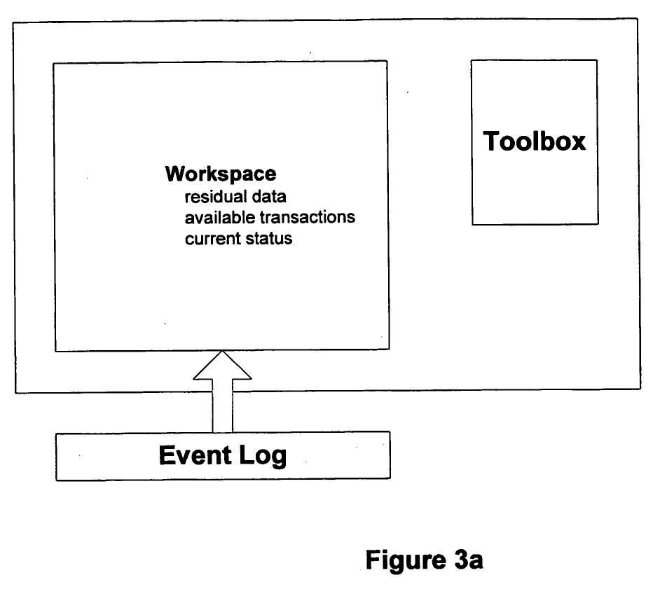

Referring now to FIG. 3b a layer 2 L2(b) type software engine is shown. The engine is similar to that of FIG. 2 except that it includes Platform Control commands to control platform API's instead of port control functionality.

FIG. 3a shows a type L2(a) software engine for interfacing between an L1 layer associated with a port and the L3 layer. The L2(a) software engines control device settings, device data, queries, defaults, limits, time out control, failure over behaviour, logs, status information, audit information, customisation, help, configuration and device identification information.

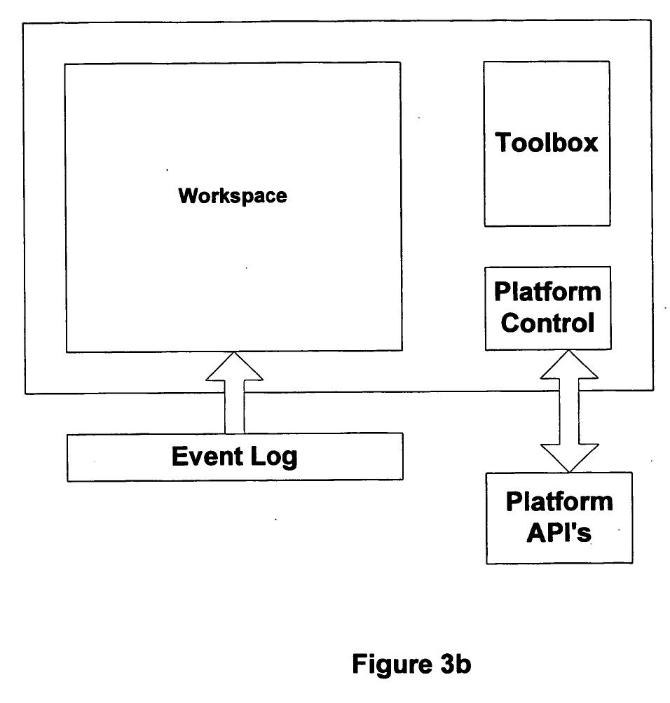

Referring now to FIG. 4 a layer 3 software engine is shown. This again utilises the same tool box and Event Log and has a Workspace dealing with residual data, transactions and status information.

Layer 3 may interact with other programs (via layer 2 and layer 1 intermediaries) when it forms part of a computer or other processor. Devices including the interface device of invention may communicate directly in a high-level data format at the L3 level (via suitable intermediaries). Communication actions may be initiated from layer 3 down to layer 1 or events at layer 1 may trigger actions at layer 3. Where the interface device is in the nature of a bridge 5 as shown in FIG. 7 operation may typically involve receiving communications at layer 1 and subsequently processing them through the appropriate layers and back to a layer 1 to output the data.

A worked example of a communication between two ports will now be described to illustrate the operation of the interface. In this example data is received at one port according to a first protocol and output at a second port according to a second protocol.

Referring firstly to FIGS. 1 and 2 data received at Port 1 is transferred to the Event Log which is a FIFO buffer. Filling the buffer or a timeout may activate an ITEL rule to operate on the data. The layer 1 software engine deals with protocol issues and performs device layer operations such as error checking. Data within the interface device consists of a 1 byte label and a 32 byte data packet. The label is used to identify the data for internal processing and may include labels such as “data in” to identify received data, “data out” to identify data to be sent, “data” identifying internal data packets, “control” to identify control packets etc. Where received data is to be operated upon it is transferred to the Workspace and the operation performed. For example, error checking to confirm a CRC may be performed.

If layer 2 requires the data, the data will be sent from the work space of layer 1 to the Workspace of layer 2. Layer 2 may then perform the required operations at its layer.

If the data is required at layer 3 the data will be sent to layer 3. Here the data may be operated upon according to any business transaction required etc. From layer 3 the data may be routed via any layer 2 to be transferred to its associated layer 1 to output the data via the associated port.

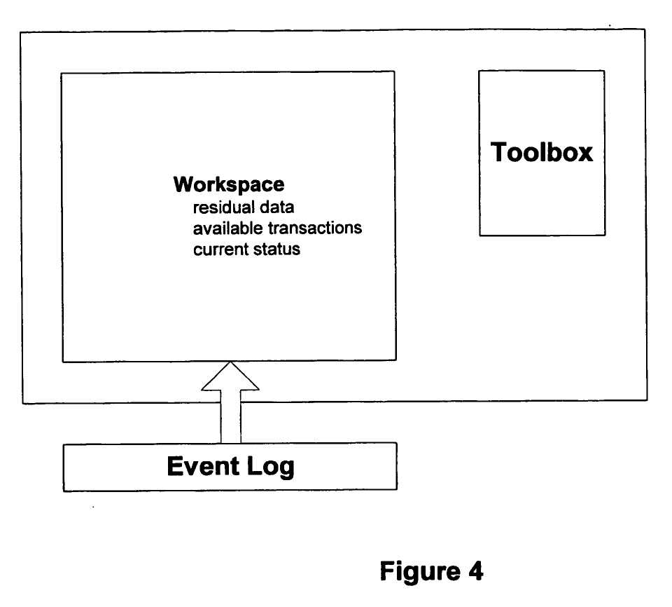

In this way data is converted from a device specific protocol received at a port to a generic form at layer 3 and can then be operated upon by any associated software at layer 3 and then output via a layer 2 and a layer 1 at any desired port to be transmitted according to the protocol of the receiving device. This operation is illustrated diagrammatically in FIG. 5.

In this manner device specific data handling is dealt with at layer 1, device specific resource issues and low level business logic operations are dealt with at layer 2 and session operations and high level (including multiple resources) business logic operations are dealt with at layer 3. Successive layers of abstraction from layer 1 to layer 3 are thus provided.

For example, to verify customer identity at a system having a connected card reader and PIN pad the following operations may occur:

Level 3

Verify customer ID

Level 2

Read card

Input current PIN

Level 1

Set up prompts

Trigger reading of card

Trigger input PIN

Next prompt

To understand the detailed operation of the software engine the following example demonstrates the steps involved in sending a message to command a device to display the message “Hello World”.

### “Hello World” Example

A PC sends a “Hello World!” command to standalone device (a PinPad), to display a message on its built-in display.

Message is “C001 Hello World!”

Steps:

PC

Creates the message.
Transmits the message to the platform over a communications link
   Layer 1 Task (for PC, Monitoring the Port)
Sitting in idle state. ITEL (Idle-Task-Event-List) engine is spinning, monitoring the Event Log (FIFO data queue).
Data is received by PortHandler (hardware layer) engine, with each data block appended to the EventLog.
After a port inactivity timeout, an RxPause event is placed in the EventLog
ITEL recognizes the RxPause event as an end-of-transmission from device, and compares the packet(s) contained in its buffer against all ACTIVE ITEL items
ITEL recognized “C001<message>”, and calls the correct Transaction (list of toolbox calls, branch logic).
An ITEL Rule (parsing structure) identifies “Hello World!” as a non-constant Data item within the buffer, and calls the correct Transaction.
Transaction extracts “Hello World!” from ITEL Rule buffer into Workspace (working memory, data types, fields).
Transaction sends Request with Data “Hello World!” up to Layer 2.
Transaction returns confirmation (to the PC) by sending a packet back out the port.
Task goes to idle state.
   Layer 2 Task (for PC, Controlling Layer 1)
Sitting in idle state. ITEL engine is spinning, monitoring the EventLog.
ITEL recognizes the Request and calls correct Transaction.
Transaction stores Data “Hello World!” (from ITEL rules) in local Workspace field; then sends Request with Data up to Layer 3.
Task goes to idle state.
   Layer 3 Task (Passes Request on to the Correct Resource/Device)
Sitting in idle state. ITEL engine is spinning, monitoring the EventLog.
ITEL recognizes the Request, checks against resource and security rules, and calls correct Transaction.
Transaction stores Data “Hello World!” (from ITEL rules) in local Workspace field; then sends Command with Data down to Layer 2 (for the device).
Task goes to idle state.
   Layer 2 Task (for PinPad, Controlling Layer 1)
Sitting in idle state. ITEL engine is spinning, monitoring the EventLog.
ITEL recognizes the Command and calls correct Transaction.
Transaction stores Data “Hello World!” (from ITEL rules) in local Workspace field.
Transaction sends (one OR more) Command, Query AND/OR Data packets down to Layer 1 (for the device).
Transaction (optionally) sets Timeout events for Device (Layer 1) response.
Task goes to idle state.
   Layer 1 Task (for PinPad, Controlling Port)
Sitting in idle state. ITEL engine is spinning, monitoring the EventLog.
ITEL recognizes the Command and calls correct Transaction.
Transaction stores Data “Hello World!” (from ITEL rules) in local Workspace field.
Transaction (optionally) sets timeout for Device (the attached device) protocol response.
Transaction calls various ToolBox (general purpose tools) items to construct a message for the particular protocol of this Device.
Transaction calls TxSend (a ToolBox item) to send data out the port, to Device.
Transaction (optionally) waits for device response, OR provides further handshaking.
Task goes to idle state.
   Device (a PinPad)
Receives message, in its proprietary protocol, over a communications link.
Displays the message “Hello World!” on its built-in display.

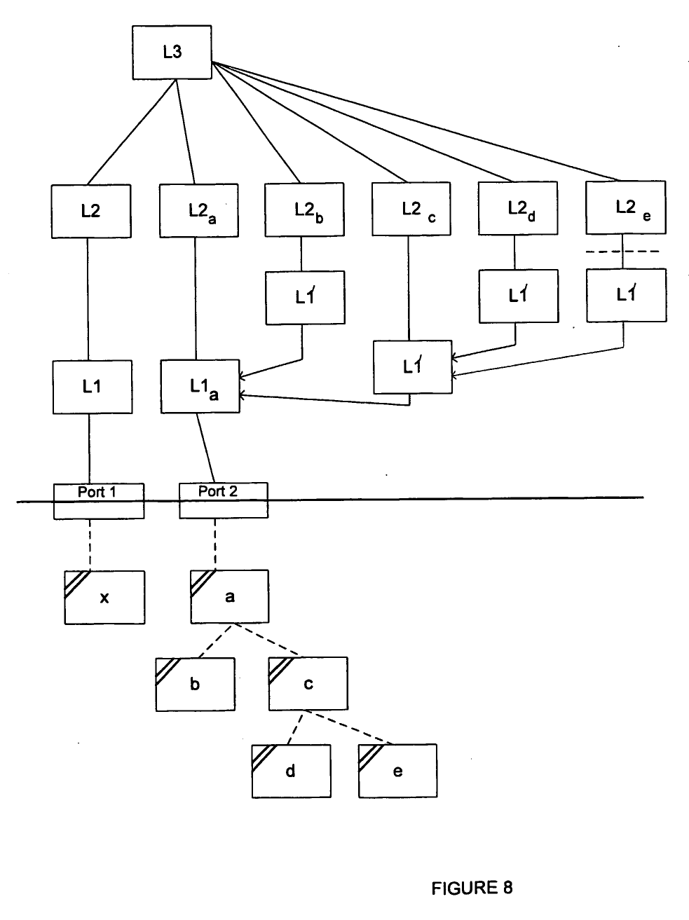

FIG. 8 shows an interface for an implementation where a single device x is connected to a first port: Port 1 and multiple devices a to e are connected to a second port: Port 2. In this implementation layer L2 software engines L2_{b-e} have modified layer 1 software engines L1′ which interface with layer 1 software engine L1ₐ and send and receive communications to and from their respective devices b to e via software engine L1a.

FIG. 9 shows a system in which interface devices 20 to 22 are interconnected. Interface devices 20 to 22 can communicate directly in “session” at layer L3 using a high-level data format (using a dedicated L1 and L2, per interface device, to send and receive this “session” protocol). Device 24 is connected to interface devices 21 via a layer L1 interface and device 25 is likewise connected to interface device 22. This allows devices 24 and 25 to be integrated and used within an application.

A console 23 is connected via serial console port directly to layer 3 of interface device 20 (using a dedicated L1 and L2 to provide a TTY command interpreter). This allows a user at console 23 to access layer L3 of interface device 20 and enter high-level commands. Via “session” the user at console 23 can interrogate devices 24 and 25 connected to interface devices 21 and 22. This allows system monitoring and control to be effected over an entire system via a dumb terminal.

The system of the invention thus simplifies and facilitates communication between a diverse range of devices. The interface device only needs to understand the interface requirements of each connected device rather than specific rules for communication between two specific devices. The invention enables communication between any device including legacy systems. The invention offers a universal device interface offering high level communication between like devices whilst allowing communication with legacy devices also.

The modular design of software objects into layers utilising common tools simplifies the system and its implementation. The separation of device specific operations, resource operations and business logic simplifies the interface device and facilitates interaction with other software modules.

Although the invention has been described in relation to computers and their associated peripheral devices the present interface is seen to have wide potential application to a wide range of devices from very low level handheld processor driven devices such as: PDA's, Calculators, Pocket Pagers, Palm Computers, Laptops/PC etc. GPS vehicle & Personnel locating systems to larger integrated PC or Host platforms with any operating system capable of presenting TTY sessions or bit stream or byte-stream functionality (e.g. Windows 95, 98, ME, 2000, XP, CE, Linux, Unix, OS/2, Macintosh).

While the present invention has been illustrated by the description of the embodiments thereof, and while the embodiments have been described in detail, it is not the intention of the Applicant to restrict or in any way limit the scope of the appended claims to such detail. Additional advantages and modifications will readily appear to those skilled in the art. Therefore, the invention in its broader aspects is not limited to the specific details, representative apparatus and method, and illustrative examples shown and described. Accordingly, departures may be made from such details without departure from the spirit or scope of the Applicant's general inventive concept.

1. A method of communicating between a first device operating under a first protocol and a second device operating under a second protocol using a plurality of processing levels, the method comprising the steps of:
a. receiving data from the first device according to the first protocol;
b. extracting the data according to a generalised intermediate data format;
c. reformatting the data according to the second protocol; and
d. transmitting the data to the second device according to the second protocol;
wherein one or more software engines are used for each of the input stage, being steps a and b, and the output stage, being steps c and d, and wherein the software engines are of a common structure and operation of each software engine is defined by configuration data related to the processing level of the software engine.

2. A method as claimed in claim 1 wherein the input stage involves multiple levels of processing at stepped levels of abstraction.

3. A method as claimed in claim 2 wherein the input stage includes a first level of processing relating to a direct interface and protocol for the first device.

4. A method as claimed in claim 2 or claim 3 wherein the input stage includes a second level of processing relating to functionality for the first device.

5. A method as claimed in any one of claims 2 to 4 wherein the input stage includes a third level of processing relating to cross-communication.

6-9. (canceled)

10. A method as claimed in any one of the preceding claims wherein each software engine includes a memory workspace and a command set.

11. A method as claimed in any one of the preceding claims wherein each software engine has a command set.

12. (canceled)

13. An interface device including:
a communications port;
a first interface layer for handling device interface with the communications port;
a second layer for handling device functionality; and
a third layer for handling cross-communication,
wherein two or more of the layers are performed by a corresponding software engine and wherein the software engines are of a common structure and operation of each software engine is defined by configuration data related to its corresponding layer.

14-16. (canceled)

17. A device as claimed in claim 16 wherein the third layer also handles business logic.

18. (canceled)

19. A device as claimed in any one of claims 16 to 18 including multiple communications ports and first and second layers wherein the second layers transfer data with the third layer, the first layers transfer data with respective second layers and the first layers control operation of the respective ports.

20. A method of transforming data from a first protocol to a second protocol by sequentially processing data by a plurality of software engines which process data at different levels of abstraction, wherein the software engines are of a common structure and operation of each software engine is defined by configuration data related to its corresponding level of abstraction.

21. (canceled)

22. A method as claimed in claim 22 wherein each software engine includes a data workspace and a common command set.

23. (canceled)

24. A method as claimed in any one of claims 22 to 23 wherein a first software engine deals with a direct interface and protocol for a connected device at a first level of abstraction.

25. A method as claimed in claim 24 wherein a second software engine deals with functionality for the connected device at a second level of abstraction.

26. A method as claimed in any one of claims 22 to 25 wherein a third software engine deals with cross-communication.

27. An interface device including a plurality of software engines each including a workspace and a command set wherein the software engines intercommunicate and process information at different levels of abstraction, wherein the highest level of abstraction provides a generalised interface, and wherein the software engines are of a common structure and operation of each software engine is defined by configuration data related to its corresponding level of abstraction.

28. (canceled)

29. A device as claimed in claim 29 wherein each software engine has a common command set.

30. (canceled)

31. A device as claimed in any one of claims 29 to 30 wherein a first software engine deals with a direct interface and protocol for a connected device at a first level of abstraction.

32. A device as claimed in claim 31 wherein a second software engine deals with functionality at a second level of abstraction.

33. A device as claimed in any one of claims 29 to 32 wherein a third software engine deals with cross-communication.

34. A system including a plurality of devices bridged by an interface device of any one of claims 16 to 21 or 29 to 35.

35. Software for effecting the method of any one of claims 1 to 15 or 22 to 35.

36. A system for providing an abstract interface to communicate with a device including:
i. a chain of two or more software engines wherein each software engine is upper interfaced to the software engines preceding it and lower interfaced to the software engine following it;
ii. a first software engine in the chain providing an upper interface; and
iii. a last software engine in the chain adapted to manage and execute a lower direct interface with a device;
wherein the upper interface of the first software engine provides a generalised interface of the highest level of abstraction and each successive member of the chain provides a decreasing level of abstraction, wherein each member transforms data received through its upper and lower interfaces according to that member's level of abstraction, and wherein the software engines are of a common structure and operation of each software engine is defined by configuration data related to its corresponding level of abstraction.

37. A system for providing an interface between a device and a plurality of devices including a plurality of systems as claimed in claim 38 wherein one or more of the first software engines are directly interfaced at the highest level of abstraction with one or more of each other and one or more of the first software engines are adapted to interface with the device.

38. A system for providing an abstract interface to a plurality of devices including:
a plurality of systems as claimed in claim 38 wherein each of the last software engines interface with one another to produce a single interface to a plurality of devices, and wherein each of the first software engines are of common design.

39. A system as claimed in claim 41 wherein the last software engines interface with one another in a branching structure such that the single interface with the plurality of devices comes from a single last software engine.

40. A system as claimed in claim 42 wherein the single last software engine is interfaced to the plurality of devices through one port.

41. A system as claimed in any one of claims 41 to 43 wherein each last software engine is associated with one of the devices.

42. A method as claimed in claim 4 wherein the second level of processing also relates to business logic.

43. A method as claimed in claim 5 wherein the third level of processing also relates to business logic.

44. A method as claimed in any one of claims 2 to 7 wherein the output stage involves multiple levels of processing at stepped levels of abstraction.

45. A method as claimed in claim 8 wherein the output stage includes a second level of processing relating to functionality for the second device.

46. A method as claimed in any one of the preceding claims wherein the output stage includes a first level of processing relating to a direct interface and protocol for the second device.

47. A method as claimed in any one of the preceding claims wherein the communication is between applications executing on the devices.

48. A method as claimed in any one of claims 1 to 12 wherein one or more of the first and second devices is executing in a console mode.

49. A method as claimed in any one of claims 1 to 12 wherein the communication is between an application executing on one of the devices and the other device.

50. A device as claimed in claim 16 wherein the second layer also handles business logic.

51. The device as claimed in any one of claims 16 to 19 wherein each software engine includes a workspace and a common command set.

52. A device as claimed in any one of claims 16 to 20 wherein the software engine for the first layer includes port control commands.

53. A method as claimed in claim 25 wherein the second software engine also deals with business logic.

54. A method as claimed in claim 26 wherein the third software engine also deals with business logic.

55. A device as claimed in claim 32 wherein the second layer also deals with business logic.

55. A device as claimed in claim 33 wherein the third layer also deals with business logic.

56. A system as claimed in claim 38 wherein the communication is with an application executing on the device.
